(19) United States
(12) Patent Application Publication
(10) Pub. No.: US 2023/0278407 A1
(43) Pub. Date: Sep. 7, 2023

(54) OUTER DOOR BELT WEATHERSTRIP FOR VEHICLE

(71) Applicants: Hyundai Motor Corporation, Seoul (KR); Kia Corporation, Seoul (KR)

(72) Inventors: Hyun Seung Park, Hwaseong (KR); Ho Lim, Suwon (KR); Dae Chul Kim, Seongnam (KR)

(21) Appl. No.: 17/897,376

(22) Filed: Aug. 29, 2022

(30) Foreign Application Priority Data
Mar. 7, 2022 (KR) 10-2022-0028477

(51) Int. Cl. B60J 10/75

(52) U.S. Cl. CPC B60J 10/75

(57) ABSTRACT

Provided is an outer door belt weatherstrip for a vehicle. The outer door belt weatherstrip has a structure in which a door belt rail is coupled to a flange portion of an outer door panel and the outer door belt weatherstrip is fitted to and coupled to an upper end of the door belt rail. Therefore, a height of the outer door belt weatherstrip that is in a coupled state may be reduced, thereby being capable of being contributing to realizing a dynamic appearance of the vehicle.

### CROSS REFERENCE TO RELATED APPLICATION

The present application is based on and claims under 35 U.S.C. § 119(a) the benefit of Korean Patent Application No. 10-2022-0028477, filed Mar. 7, 2022, the entire contents of which are incorporated herein for all purposes by this reference.

### TECHNICAL FIELD

The present disclosure relates to an outer door belt weatherstrip for a vehicle. More particularly, the present disclosure relates to a technology about an outer door belt weatherstrip for a vehicle, the outer door belt weatherstrip being capable of contributing to realizing a dynamic appearance of the vehicle by reducing a coupling height of the outer door belt weatherstrip.

### BACKGROUND

Generally, a door belt weatherstrip of a vehicle includes an inner door belt weatherstrip and an outer door belt weatherstrip. Further, the inner door belt weatherstrip is coupled to an upper end of a door inner panel and is in close contact with an inner surface of a door glass, and the outer door belt weatherstrip is coupled to an upper end of an outer door panel and is in close contact with an outer surface of the door glass. Through this, rainwater or dust is blocked from being introduced inside a door panel, and vibration and shaking of the door glass are prevented.

When the outer door belt weatherstrip is assembled, the outer door belt weatherstrip is positioned at an upper portion of the outer door panel, and then is moved downward such that the upper end of the outer door panel is fitted into an inside of the outer door belt weatherstrip, thereby assembling the outer door belt weatherstrip.

That is, conventionally, the outer door belt weatherstrip has a structure in which the outer door belt weatherstrip is fitted to and coupled to a hemming portion that is provided at the upper end of the outer door panel. Therefore, there is a disadvantage that the conventional outer door belt weatherstrip has a high coupling height.

One of factors that greatly affects a dynamic in a side view image of a vehicle is a door belt line, and the characteristics of vehicle design largely depend on the shape and the angle of the door belt line.

Therefore, as same as the conventional structure of the outer door belt weatherstrip, when the coupling height of the outer door belt weatherstrip is high, there is a limit in realizing a dynamic appearance of the vehicle, so that there is a disadvantage that the commercial value of the vehicle is adversely affected.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and an objective of the present disclosure is to provide an outer door belt weatherstrip for a vehicle, the outer door belt weatherstrip being coupled to a door belt rail, and the outer door belt weatherstrip being capable of reducing a height thereof in a coupled state by being configured such that a coupling height thereof is set as a minimum height, thereby being capable of contributing to realizing a dynamic appearance of the vehicle so that the commercial value of the vehicle can be improved.

In one aspect, an outer door belt weatherstrip for a vehicle is provided, the weatherstrip suitably comprising an outer door belt weatherstrip element configured to being coupled to a door belt rail that is in contact with an outer door panel, and the outer door belt weatherstrip being configured to maintain airtightness between a door glass and the outer door panel by being in contact with the door glass and the outer door panel. Suitably, the outer door belt weatherstrip is configured such that a gap between the door glass and the outer door panel is effectively sealed, for example to provide effective vehicle airtightness.

In another aspect, provided is an outer door belt weatherstrip for a vehicle, the outer door belt weatherstrip being fitted to and coupled to a door belt rail that is in contact with an outer door panel, and the outer door belt weatherstrip being configured to maintain airtightness between a door glass and the outer door panel by being in contact with the door glass and the outer door panel such that a gap between the door glass and the outer door panel is sealed.

In some embodiments, a flange portion that extends downward may be formed by bending an upper end of the outer door panel downward, and the outer door belt weatherstrip may be fitted to and coupled to an upper end of the door belt rail that is coupled to the flange portion of the outer door panel.

In some embodiments, the door belt rail may be coupled such that a top of the upper end of the door belt rail does not protrude above the outer door panel, so that the outer door belt weatherstrip coupled to the door belt rail may be configured such that a height of the outer door belt weatherstrip protruding above the outer door panel can be minimized.

In some embodiments, the outer door belt weatherstrip may include: a weatherstrip body forming an overall appearance of the outer door belt weatherstrip; an inner lip and an outer lip that are respectively coupled to the door glass and the outer door panel by being coupled to the weatherstrip body; and a clip that is coupled to the weatherstrip body by being inserted inside the weatherstrip body and is fitted to and coupled to the upper end of the door belt rail.

In some embodiments, the weatherstrip body may be configured such that only a head portion which is positioned at a top-most of the weatherstrip body and to which the outer lip is coupled protrudes above the outer door panel, so that a height of the outer door belt weatherstrip protruding above the outer door panel can be minimized.

In some embodiments, a coupling hole may be formed in the door belt rail, a clip protrusion may be formed on the clip, and the clip protrusion may be fitted into and coupled to the coupling hole.

In some embodiments, an upper end of the clip may be inserted into and coupled to an inner space of the weatherstrip body, and a lower end of the clip may have a U-shaped locking portion and a lower end of the weatherstrip body may be fitted into the locking portion.

In some embodiments, the weatherstrip body may be integrally formed by bending one steel panel multiple times through performing a roll forming process.

In some embodiments, the inner lip and the outer lip may be formed of a rubber material, and are integrally coupled to the weatherstrip body by performing an injection molding process.

In some embodiments, the clip may be formed of a plastic material.

In an exemplary embodiment of the present disclosure, by using the structure in which the door belt rail is coupled to the flange portion of the outer door panel and the outer door belt weatherstrip is fitted to and coupled to the upper end of the door belt rail, a protrusion height of the outer door belt weatherstrip that is coupled to the door belt rail is set as a minimum height, so that a height of the outer door belt weatherstrip that is in a coupled state can be reduced, thereby contributing to realizing a dynamic appearance of the vehicle. Therefore, there is an effect that the commercial value of the vehicle can be improved.

As discussed, the method and system suitably include use of a controller or processer.

In another embodiment, vehicles are provided that comprise an outer door belt weather strip as disclosed herein.

In one aspect, vehicles are provided that comprise an outer door belt weatherstrip coupled to a door belt rail that is in contact with an outer door panel, and the outer door belt weatherstrip maintaining airtightness between a door glass and the outer door panel by being in contact with the door glass and the outer door panel. In certain aspects, a gap door glass and the outer door panel is at least substantially sealed to provide effective airtightness. As referred to herein, airtightness can be assessed by known methods including as disclosed in U.S. Pat. No. 5,780,723 to Kia.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a side view illustrating a vehicle in which an outer door belt weatherstrip according to the present disclosure is applied;

FIG. 2 is an enlarged view of portion A in FIG. 1;

FIG. 3 is a cross-sectional view taken along line I-I in FIG. 2; and

FIG. 4 is a view illustrating a state in which a weatherstrip body and clips are coupled to each other according to the present disclosure.

### DETAILED DESCRIPTION

In the following description, the structural or functional description specified to exemplary embodiments according to the concept of the present disclosure is intended to describe the exemplary embodiments, so it should be understood that the present disclosure may be variously embodied, without being limited to the exemplary embodiments.

Embodiments described herein may be changed in various ways and various shapes, so specific embodiments are shown in the drawings and will be described in detail in this specification. However, it should be understood that the exemplary embodiments according to the concept of the present disclosure are not limited to the embodiments which will be described hereinbelow with reference to the accompanying drawings, but all of modifications, equivalents, and substitutions are included in the scope and spirit of the present disclosure.

It will be understood that although the terms first and/or second, etc. may be used herein to describe various elements, these elements should not be limited by these terms. The above terms are only for the purpose of distinguishing one component from other components, for example, without departing from the scope of the rights according to the concept of the present disclosure, the first component may be referred to as the second component, and similarly the second component may also be referred to as a first component.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent”, or “directly adjacent” should be interpreted in the same manner as those described above.

The terminology used herein is for the purpose of describing particular embodiments only and is not intended to limit the present disclosure. Singular expressions include plural expressions unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless otherwise defined, all terms including technical and scientific terms used herein have the same meaning as commonly understood by those skilled in the art to which the present disclosure belongs. Terms such as those defined in a commonly used dictionary should be interpreted as having a meaning consistent with the meaning of the related technology, and should not be interpreted as an ideal or excessively formal meaning unless explicitly defined in the present specification.

In an exemplary embodiment of the present disclosure, a controller may be realized by a non-volatile memory (not shown) configured to store an algorithm for controlling the operation of various elements of a vehicle or data on software commands for executing the algorithm and a processor (not shown) configured to perform an operation, which will be described below, using the data stored in the memory. Here, the memory and the processor may be realized as individual chips. Alternatively, the memory and the processor may be realized as a single integrated chip. The processor may include one or more processors.

Hereinafter, an outer door belt weatherstrip for a vehicle according to an exemplary embodiment of the present disclosure will be described with reference to the accompanying drawings.

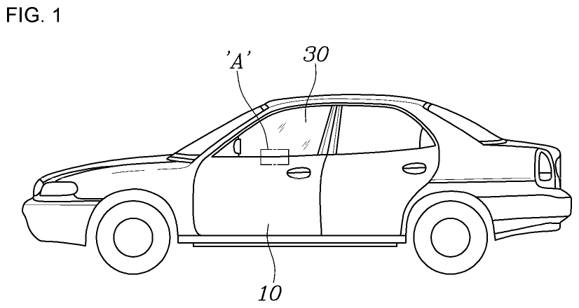

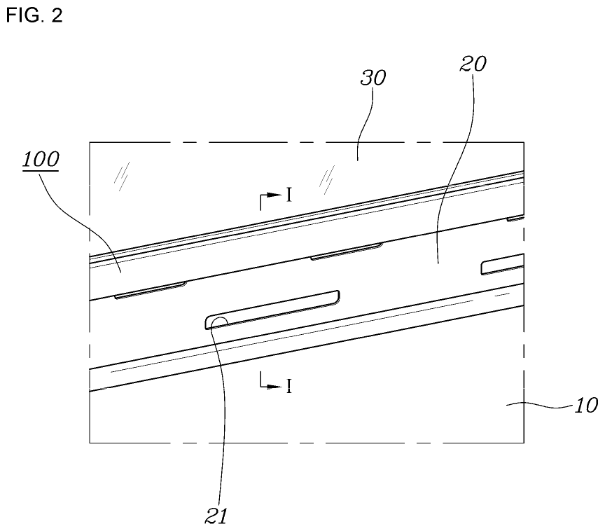

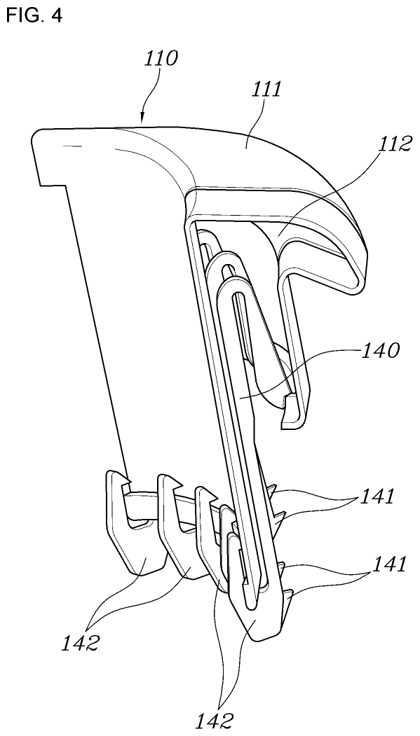

As illustrated in FIGS. 1 to 4, an outer door belt weatherstrip 100 for a vehicle according to the present disclosure may be coupled to a door belt rail 20 by being fitted to the door belt rail 20 that is in contact with an outer door panel 10. Further, in a state in which the outer door belt weatherstrip 100 is coupled to the door belt rail 20, the outer door belt weatherstrip 100 may serve to maintain airtightness between a door glass 30 and the outer door panel 10 by being in contact with the door glass 30 and the outer door panel 10 such that a gap between the door glass 30 and the outer door panel 10 is sealed.

The outer door belt weatherstrip 100 according to the present disclosure may be in close contact with an outer surface of the door glass 30 by being coupled to an upper end of the door belt rail 20 that is coupled to the outer door panel 10. Through this, rainwater or dust is blocked from being introduced inside a door panel in which the door glass 30 is accommodated, and vibration and shaking of the door glass 30 are prevented.

According to the present disclosure, in the outer door panel 10, an upper end of the outer door panel 10 may be bent in a direction toward the door glass 30 and may be bent again downward, so that a flange portion 11 that extends downward is formed.

In addition, the door belt rail 20 may be positioned at a side portion of the flange portion 11, and a lower end of the flange portion 11 and a lower end of the door belt rail 20 may be coupled to each other through a structural adhesive while being in contact with each other.

The door belt rail 20 may be disposed on an upper portion of the outer door panel 10 and extend in a front and rear direction of the vehicle, and a cross-section of the door belt rail 20 may extend vertically along the flange portion 11 of the outer door panel 10.

The lower end of the door belt rail 20 and the lower end of the flange portion 11 of the outer door panel 10 may be in contact with and coupled to each other. Further, the upper end of the door belt rail 20 and an upper end of the flange portion 11 are spaced apart from each other, so that a space having a predetermined size is formed therebetween.

The outer door belt weatherstrip 100 according to the present disclosure may have a structure in which the outer door belt weatherstrip 100 is fitted to and coupled to the upper end of the door belt rail 20 that is coupled to the flange portion 11 of the outer door panel 10.

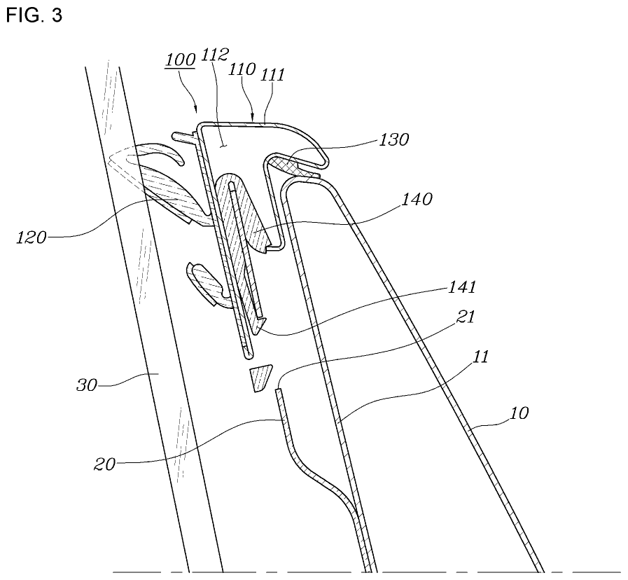

At this time, as illustrated in FIG. 3, the door belt rail 20 may be coupled such that the upper end of the door belt rail 20 does not protrude above the outer door panel 10. Therefore, a coupling height, which protrudes above the outer door panel 10, of the outer door belt weatherstrip 100 that is coupled to the door belt rail 20 may be minimized.

In a conventional structure, there has been a structure in which a hemming portion is formed on an upper end of an outer door panel, and the upper end of the outer door panel and an upper end of a door belt rail are coupled to each other by using the hemming portion, and then an outer door belt weatherstrip is fitted to and coupled to the hemming portion by moving the outer door belt weatherstrip downward from an upper portion of the hemming portion.

Therefore, the conventional outer door belt weatherstrip coupled to the hemming portion has a coupling height that is high as much as a length of the hemming portion that extends in a vertical direction. Further, since the coupling height of the conventional outer door belt weatherstrip is high, there is a limit in realizing a dynamic appearance of a vehicle, so that there is a disadvantage that the commercial value of the vehicle is adversely affected.

On the contrary, a structure according to the present disclosure may be configured such that the flange portion 11 that extends downward from the upper end of the outer door panel 10 is formed, the flange portion 11 and the door belt rail 20 are coupled to each other, and the outer door belt weatherstrip 100 is coupled to the upper end of the door belt rail 20 by fitting the outer door belt weatherstrip 100 to the upper end of the door belt rail 20 from the top to the bottom.

Particularly, the structure according to the present disclosure may be configured such that the outer door belt weatherstrip 100 is fitted to and coupled to the upper end of the door belt rail 20 while the upper end of the door belt rail 20 does not protrude above the outer door panel 10. Due to this structure, there is an advantage that a protrusion height of the outer door belt weatherstrip 100 that is coupled to the door belt rail 20 can be minimized. Through this, there is an advantage that the commercial value of the vehicle can be improved by contributing to realizing a dynamic appearance of the vehicle.

The outer door belt weatherstrip 100 according to the present disclosure may include: a weatherstrip body 110 forming an overall appearance of the outer door belt weatherstrip 100; an inner lip 120 and an outer lip 130 that are respectively in contact with the door glass 30 and the outer door panel by being coupled to the weatherstrip body 110; and a clip 140 which is coupled to the weatherstrip body 110 by being inserted inside the weatherstrip body 110 and which is coupled to and fitted to the upper end of the door belt rail 20.

The weatherstrip body 110 may be provided with a head portion 111 that is positioned at the top most of the weatherstrip body 110, and the outer lip 130 is coupled to a bottom surface of the head portion 111, so that a structure in which the outer lip 130 is in contact with the upper end of the outer door panel is formed.

When the clip 140 is fitted to and coupled to the upper end of the door belt rail 20, only the head portion 111 of the weatherstrip body 110 to which the outer lip 130 is coupled may protrude above the outer door panel 10. Therefore, there is an advantage that a height of the outer door belt weatherstrip 100 that protrudes above the outer door panel 10 can be minimized.

According to the present disclosure, a coupling hole 21 may be formed in the door belt rail 20, and a clip protrusion 141 may be formed on the clip 140. Therefore, a structure in which the clip protrusion 141 is fitted to and coupled to the coupling hole 21 is formed.

The coupling hole 21 may be formed in a slot-shaped hole that extends along the front and rear direction of the vehicle which is a longitudinal direction of the door belt rail 20, and a plurality of coupling holes 21 may be spaced apart from each other along the front and rear direction.

The clip protrusion 141 that protrudes in a direction toward the door belt rail 20 may be formed on the clip 140.

The clip protrusion 141 may be formed such that an upper surface of a cross-section of the clip protrusion 141 has a right-angled surface and a lower surface of a cross-section of the clip protrusion 141 has an inclined surface.

Therefore, when the clip 140 is fitted to the upper portion of the door belt rail 20, the clip 140 may be fitted into and coupled to the coupling hole 21. Through this, the outer door belt weatherstrip 100 is coupled to the coupling hole 21 that is formed at a predetermined position in the door belt rail 20, so that a coupled position and a coupling height can be uniformly fixed and maintained.

When the clip protrusion 141 is fitted into the coupling hole 21, a worker may feel a snapping feeling and may simultaneously recognize a sound. Through this, the worker may easily recognize an assembly completion state of the outer door belt weatherstrip 100, so that a defective assembly situation due to a defective insertion may be prevented.

In addition, after the clip protrusion 141 is fitted into the coupling hole 21 and the assembly is completed, a locked state may be maintained by the right-angled surface that is the upper surface of the clip protrusion 141, so that a falling off situation of the outer door belt weatherstrip 100 may be prevented.

After the outer door belt weatherstrip 100 is coupled as the clip 140 is assembled with the door belt rail 20, the inner lip 120 maintains airtightness by being in contact with the outer surface of the door glass 30, and the outer lip 130 maintains airtightness by being in contact with the upper end of the outer door panel 10.

According to the present disclosure, an upper end of the clip 140 may be inserted into and coupled to an inner space 112 of the weatherstrip body 110, and a lower end of the clip 140 may have a U-shaped locking portion 142 and the lower end of the weatherstrip body 110 may be fitted into the locking portion 142. Through this, a coupling between the weatherstrip body 110 and the clip 140 may be more tightly maintained.

According to the present disclosure, a plurality of clips 140 may be coupled to one weatherstrip body 110. At this time, the plurality of clips 140 is disposed to be spaced apart from each other in the front and rear direction.

The weatherstrip body 110 according to the present disclosure may be integrally formed by bending one steel panel multiple times through a roll forming process. Through this, reduction in the number of components, reduction in cost, and stronger rigidity and strength may be provided.

The inner lip 120 and the outer lip 130 according to the present disclosure may be formed of a rubber material that is advantageous for maintaining airtightness, and have a structure in which the inner lip 120 and the outer lip 130 are integrally coupled to the weatherstrip body 110 by performing an injection molding process.

In addition, it is preferable that the clip 140 according to the present disclosure may be formed of a plastic material which has characteristics of easy manufacturability, low cost, and light weight, but is not limited thereto.

As described above, in an exemplary embodiment of the present disclosure, provided is a structure in which the door belt rail 20 is coupled to the flange portion 11 of the outer door panel 10 and the outer door belt weatherstrip 100 is fitted to and coupled to the upper end of the door belt rail 20. Therefore, the protrusion height of the outer door belt weatherstrip 100 that is coupled to the door belt rail is set as a minimum height, so that a coupling height can be minimized. Through this, the commercial value of the vehicle can be improved by being capable of contributing to realizing the dynamic appearance of the vehicle.

Although exemplary embodiments of the present disclosure have been described herein, it is understood that the present disclosure should not be limited to these exemplary embodiments and that various changes and modifications can be made by one ordinary skilled in the art within the spirit and scope of the present disclosure.

What is claimed is:

1. An outer door belt weatherstrip for a vehicle, comprising:
an outer door belt weatherstrip element configured to being coupled to a door belt rail that is in contact with an outer door panel, and
the outer door belt weatherstrip being configured to maintain airtightness between a door glass and the outer door panel by being in contact with the door glass and the outer door panel.

2. The outer door belt weatherstrip for a vehicle of claim 1 wherein the outer door belt weatherstrip is configured such that a gap between the door glass and the outer door panel is effectively sealed.

3. The outer door belt weatherstrip of claim 1, wherein a flange portion extends downward from the outer door panel is formed by bending an upper end of the outer door panel downward.

4. The outer door belt weatherstrip of claim 3, wherein the outer door belt weatherstrip is fitted to and coupled to an upper end of the door belt rail that is coupled to the flange portion of the outer door panel.

5. The outer door belt weatherstrip of claim 4, wherein the door belt rail is coupled such that a top of the upper end of the door belt rail does not protrude above the outer door panel, so that the outer door belt weatherstrip coupled to the door belt rail is configured such that a height of the outer door belt weatherstrip protruding above the outer door panel can be minimized.

6. The outer door belt weatherstrip of claim 4, wherein the outer door belt weatherstrip comprises:
a weatherstrip body forming an overall appearance of the outer door belt weatherstrip;
an inner lip and an outer lip that are respectively coupled to the door glass and the outer door panel by being coupled to the weatherstrip body; and
a clip that is coupled to the weatherstrip body by being inserted inside the weatherstrip body and is fitted to and coupled to the upper end of the door belt rail.

7. The outer door belt weatherstrip of claim 6 wherein the weatherstrip body is configured such that only a head portion which is positioned at a top most of the weatherstrip body and to which the outer lip is coupled protrudes above the outer door panel, so that a height of the outer door belt weatherstrip protruding above the outer door panel can be minimized.

8. The outer door belt weatherstrip of claim 6, wherein a coupling hole is formed in the door belt rail, a clip protrusion is formed on the clip.

9. The outer door belt weatherstrip of claim 8, wherein the clip protrusion is fitted into and coupled to the coupling hole.

10. The outer door belt weatherstrip of claim 6, wherein an upper end of the clip is inserted into and coupled to an inner space of the weatherstrip body.

11. The outer door belt weatherstrip of claim 10, wherein a lower end of the clip has a U-shaped locking portion and a lower end of the weatherstrip body is fitted into the locking portion.

12. The outer door belt weatherstrip of claim 6, wherein the weatherstrip body is integrally formed by bending one steel panel multiple times through performing a roll forming process.

13. The outer door belt weatherstrip of claim 6, wherein the inner lip and the outer lip are formed of a rubber material.

14. The outer door belt weatherstrip of claim 13, wherein the inner lip and the outer lip are integrally coupled to the weatherstrip body by performing an injection molding process.

15. The outer door belt weatherstrip of claim 6, wherein the clip is formed of a plastic material.

16. A vehicle comprising the outer door belt weatherstrip of claim 1.

17. A vehicle comprising:
an outer door belt weatherstrip coupled to a door belt rail that is in contact with an outer door panel, and
the outer door belt weatherstrip maintaining airtightness between a door glass and the outer door panel by being in contact with the door glass and the outer door panel.

18. The vehicle of claim 17 wherein a gap door glass and the outer door panel is at least substantially sealed to provide effective airtightness.
